(19) United States
(12) Patent Application Publication
(10) Pub. No.: US 2006/0130352 A1
(43) Pub. Date: Jun. 22, 2006

(54) Measuring tape for tape rule

(75) Inventor: Jason Huang, Taipei (TW)

Correspondence Address: DENNISON, SCHULTZ, DOUGHERTY & MACDONALD, 1727 KING STREET, SUITE 105, ALEXANDRIA, VA, 22314, US

(73) Assignee: INDEX MEASURING TAPE CO, LTD.

(21) Appl. No.: 11/014,875

(22) Filed: Dec. 20, 2004

(51) Int. Cl. G01B 3/10

(52) U.S. Cl. 33/771

(57) ABSTRACT

Disclosed is a measuring tape for tape rule consisting of a metallic main body formed into concave upwards shape with a hook provided to its free end, and is labeled with successive graduations and numerals as scales on its upper surface. A transparent protective layer is respectively provided on its upper and lower surface by coating. The front section of the tape near its free end is further protected by enhancing protective layers in proper length by coating on both surfaces of the tape.

### BACKGROUND OF THE INVENTION

1. The Field of the Invention

The present invention relates to a measuring tape for tape rule; and in particular, to a measuring tape each of whose surfaces is coated with a layer of transparent painting to cover the graduations and numerals, and its front section with a length approximately 0˜150 cm (0˜59 inch) which is frequently pulled out for measuring is coated at least one protecting layer on both upper and lower surfaces.

2. Description of the Prior Art

As shown in FIG. 1, a conventional tape rule consists of a housing 100 with a push button 101 provided on it above an exit 300 of a measuring tape 200 so as to control extension and retrieval of the tape 200.

As shown in FIG. 2, the conventional measuring tape 200 is a long, narrow and thin metallic belt wound on a robbin and elongated outside of the housing 100 for measuring work and retrieved into the housing 100 after finishing the measuring work. The tape 200 when stowed in the housing 100 is wound around the robbin. The elongated tape 200 is wound back into the housing 100 by resilient force of a coil spring (not shown) fastened between the robbin and the housing 100.

However, elongating and retrieving the tape too frequent may wear the front section (the part with length 0˜150 cm or 0˜59 inch) of the tape 200 by scraping of the user's finger claws on it or possible abrasion by a frictional contract with the edge of tape exit 300. Moreover, the numerals 201 and graduation scales 202 provided on that part of the tape 200 will be worn out accordingly, and from worse to worst, the tape 200 probably will be broken by cracks built up on it by the applied tensile force during frequent reciprocation of the tape 200 thereby greatly shortening the lifetime of the tape rule.

To improve such noticeable defects on the prior art, the inventor has dedicated great efforts for years to studying and improving theses defects and come up with a novel measuring tape for the tape rule as provided in this invention to eliminate the defects mentioned above.

### SUMMARY OF THE INVENTION

Accordingly, the main object of the present invention is to provide a measuring tape for the tape rule in which the front section of the tape with a length about 0˜150 cm, or 0˜59 inch where being frequently touched by the user, is coated with a protective layer, both on the upper and lower surfaces, to cover the transparent layers formed underneath so as to protect the abrasion of the tape from scraping by user's finger claws and fading of the graduations and numerals of the scale labeled thereon so as to prolong the lifetime of the tape rule.

Another object of the present invention is that the coated protective layer has a strong adhesion being not easily exfoliated by contact of the user's finger.

Still another object of the present invention is that one or two enhancing protective layer is made of the painting material such as nylon or others well adhesive to the tape surface.

The above objects and other advantages of the present invention will become more apparent by describing in detail the preferred embodiments of the present invention with reference to the attached drawing.

### BRIEF DESCRIPTION OF THE DRAWINGS

FIG. 1 is a three dimensional view of a conventional tape rule;

FIG. 2 is a schematic view of a conventional measuring tape showing its front section;

FIG. 3 is a three dimensional view of a measuring tape of the present invention;

FIG. 4 is a transverse cross sectional view of a measuring tape of the present invention;

FIG. 5 is a transverse cross sectional view of a measuring tape in another embodiment of the present invention; and

FIG. 6 is a schematic view of a tape rule accompanied with the measuring tape of the present invention.

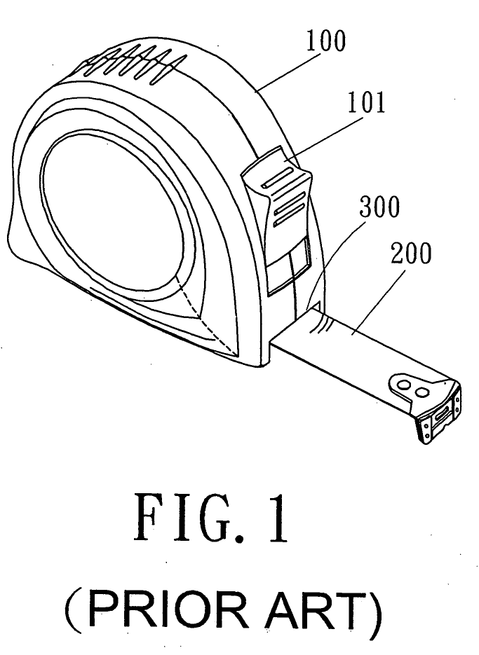

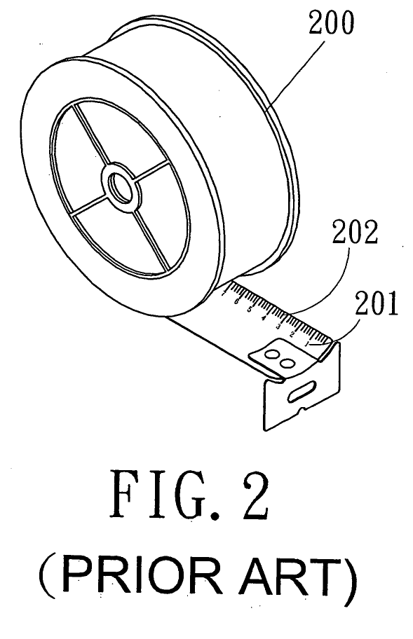

### DETAILED DESCRIPTION OF THE PREFERRED EMBODIMENTS

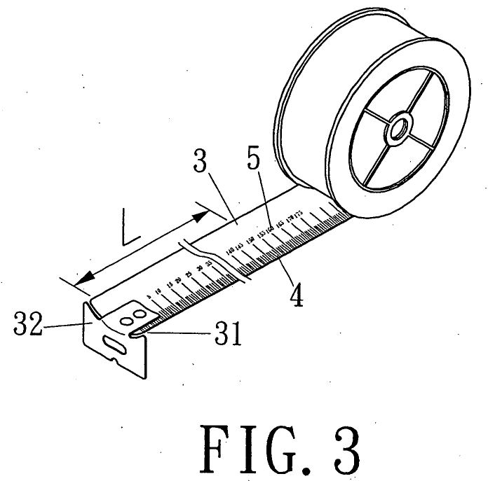

Referring to FIG. 3, in which a three dimensional view of the measuring tape provided by the present invention is shown. The measuring tape 3, made of a thin metal sheet, preferably steel is formed into concave upwards shape and is labeled with successive graduations 4 and numerals 5 as scales for measuring length or distance. One end of the tape 3 is fastened to a robbin (not shown), whereas the other end is a free end 31 with a hook 32 to be pulled out of the tape rule for measuring work by fixing the hook 32 on certain place.

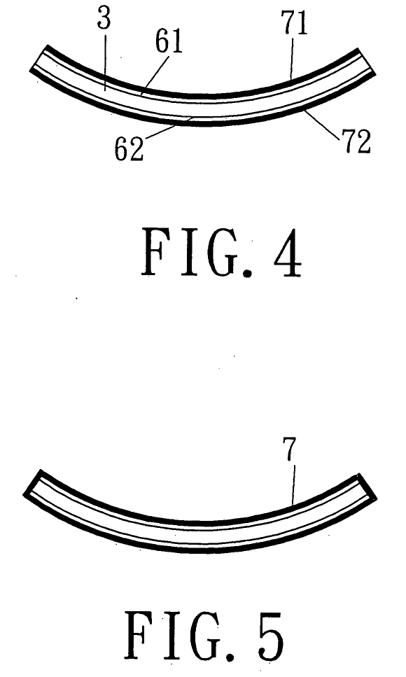

Referring to FIG. 4, in the transverse cross sectional view of the tape 3, it is shown that after being labeled graduations 4 and numerals 5 on the upper surface of the tape 3, transparent protective layers 61 and 62 are coated respectively on the upper and lower surfaces of the tape 3 so as protect the graduations 4 and numerals 5 from fading away by friction. Besides, in order to protect the front section L of the tape 3 near its free end 31 with the length about 0˜150 cm (0˜59 inch) where it suffers from a severe abrasion by frequent reciprocating motion of the tape 3, one or more enhancing protective layers 71 and 72, which being made of nylon or other well adhesive material can be respectively coated on the upper and lower surface 61,62 of the tape 3.

In another embodiment of the present invention shown in FIG. 5, for improving protection, both longitudinal edges of the tape 3 are also coated with the enhancing protective layer such that the overall surfaces of the tape 3 are completely sieged by a integrate enhancing protective layer 7.

In addition, the enhancing protective layers may be colored or added with a fluorescent material so as to facilitate visual identification during measuring work.

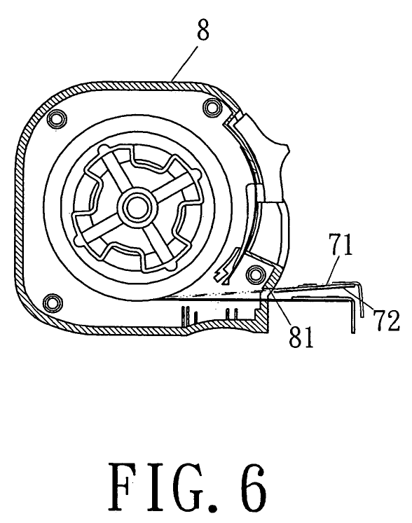

Referring to FIG. 6, when using a tape rule 8 associated with the measuring tape 3, as its front section is well protected by the enhancing protective layers 71, 72 with increased thickness, the user is free from the worry that his/her fingers might be cut by the edges of moving tape 3, and the tape 3, and the tape 3 itself is also free from the worry of cracking or even breaking by forcible impact at the fringe of its exit 81 with high retrieving speed.

It emerges from the above description that the measuring tape provided by the present invention has several noteworthy advantages compared with the conventional ones, namely:
1. The front section of the measuring tape is well protected by the double protecting layers from cracking or breaking.
2. The graduations and numerals of the scales never fade away as being coated with a transparent layer.
3. No worry of hurting the user's hand because both edges of the tape are enclosed by protective layers.

Those who are skilled in the art will readily perceive how to modify the invention. Therefore, the appended claims are to be construed to cover all equivalent structures which fall within the true scope and spirit of the invention.

What is claimed is:

1. A measuring tape for tape rule comprising a metallic main body formed into concave upwards shape with a hook provided to its free end, and being labeled with successive graduations and numerals as scales on its upper surface thereof, a transparent protective layer being respectively provided on the upper and lower surface of said tape by coating; wherein the front section of said tape near its free end is further protected by enhancing protective layers in proper length by coating on both upper and lower surfaces of said tape.

2. The measuring tape as in claim 1, wherein the proper length of said front section to be coated is about 0˜150 cm or 0˜59 inch.

3. The measuring tape as in claim 1, wherein said enhancing protecting layer is provided to the overall surfaces of said tape including both longitudinal edges so as to completely siege said measuring tape.

4. The measuring tape as in claim 1, wherein said protective layer is made of nylon.

5. The measuring tape as in claim 1, wherein said protective layer is single or double.

6. The measuring tape as in claim 1, wherein said protective layer is transparent or colored.
